(19) United States
(12) Patent Application Publication
(10) Pub. No.: US 2002/0129041 A1
(43) Pub. Date: Sep. 12, 2002

(54) Function/service based automatic import/distribution of data

(76) Inventors: Jay R. Anderson, Sammamish, WA (US); Thomas Sherman McCullagh, Redmond, WA (US); Daniel R. Bone, Cheney, WA (US)

Correspondence Address: COLUMBIA IP LAW GROUP, PC, 10260 SW GREENBURG ROAD, SUITE 820, PORTLAND, OR, 97223, US

(21) Appl. No.: 10/038,148

(22) Filed: Jan. 3, 2002

Related U.S. Application Data
(60) Provisional application No. 60/259,998, filed on Jan. 5, 2001.

(51) Int. Cl. G06F 17/30

(52) U.S. Cl. 707/200

(57) ABSTRACT

A data importer/distributor is advantageously equipped to detect presence of applications, identify importable data of the applications, including the function/service affiliation of the importable data, and automatically import or distribute the data to the applications in a function/service based manner, subject to optional user overrides. In one embodiment, the applications are provided with descriptors describing at least their presence criteria, and data subscribed by the application, including the data's function/service affiliations, through reference to data items/types of a cross application function/service based data classification model. In one embodiment, the data importer/distributor is incorporated as part of a processor based computing device.

### RELATED APPLICATION

This is a non-provisional application of provisional application 60/259,998, filed on Jan. 5, 2001, and claims priority to the '998 application.

### BACKGROUND OF THE INVENTION

1. Field of the Invention

The present invention relates to the field of data processing. More specifically, the present invention relates to the export of data from one or more applications, and automatic import or distribution of the exported data into one or more other applications (with optional rule based direction of the otherwise automatic import/distribution process).

2. Background Information

Ever since the introduction of digital computing, there has always been a need to move data from one or more applications to one or more other applications, for synchronization, migration and/or other purposes. Prior art data moving techniques are typically application specific, limiting in the type of data they support, and so forth.

With advances in integrated circuit and microprocessor, low cost and yet powerful processor based computing devices are being introduced in an ever increasing rate, resulting in their wide spread adoption, and therefore the profileration of a wide range of data, as well as frequent migration between computing platforms.

Thus, an improved approach to exporting data from applications, and importing or distributing them to other applications, preferably in an automated manner, but permitting optional distribution time direction, without some of the prior art limitations, is desired.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIGS. 2a-2e illustrate the descriptors of FIG. 1 in further details, in accordance with one embodiment;

FIGS. 3a-3c illustrate the cross application function/service based data classification model of FIG. 1 in further details, in accordance with one embodiment;

FIG. 4 illustrates the operation flow of the relevant aspects of the data exporter of FIG. 1 in further details, in accordance with one embodiment;

FIG. 5 illustrates the function/service based datasets of FIG. 1 in further details, in accordance with one embodiment;

FIG. 6 illustrates the operation flow of the relevant aspects of the data importer/distributor of FIG. 1 in further details, in accordance with one embodiment; and

FIG. 7 illustrates an internal component view of a digital system suitable for use to practice the present invention, in accordance with one embodiment.

### DETAILED DESCRIPTION OF THE INVENTION

The present invention includes a novel approach to exporting data from one or more applications, and automatically importing or distributing the exported data to one or more other applications, with optional rule based direction of the otherwise automatic import/distribution process.

In the description to follow, various aspects of the present invention will be described, and specific configurations will be set forth. However, the present invention may be practiced with only some or all aspects, and/or without some of these specific details. In other instances, well-known features are omitted or simplified in order not to obscure the present invention.

The description will be presented in terms of operations performed by a processor based device, using terms such as multi-media contents, requesting, downloading, rendering, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical, electrical and/or optical components of the processor based device.

Moreover, the term “processor” includes microprocessors, micro-controllers, digital signal processors, and the like, that are standalone, adjunct or embedded. Further, the term “processor based computing devices” (hereinafter, simply computing devcie) includes but are not limited to wireless mobile phones, palm sized personal digital assistants, notebook computers, desktop computers, set-top boxes, game consoles, servers, and so forth.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The description repeatedly uses the phrase “in one embodiment”, which ordinarily does not refer to the same embodiment, although it may. The terms “comprising”, “including”, “having”, and the like, as used in the present application, are synonymous.

### Overview

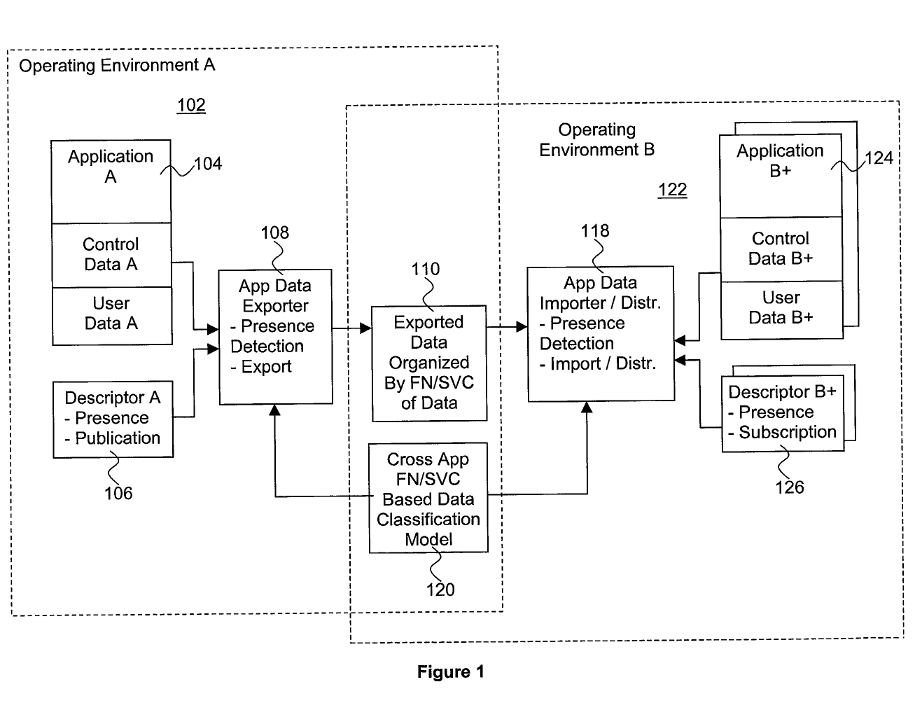

Referring now to FIG. 1, wherein a block diagram illustrating an overview of the present invention, in accordance with one embodiment, is shown. As illustrated, in accordance with a first aspect of the present invention, operating environment A 102, where application A 104 is installed, is advantageously provided with application data exporter 108 incorporated with the teachings of the present invention, to facilitate export of data associated with application A 104 in a more movable function/service based manner. In accordance with another aspect of the present invention, operating environment B 122, where applications B+ 124 are installed, is advantageously provided with application data importer/distributor 118 incorporated with the teachings of the present invention, to facilitate automatic import or distribution of exported data to applications B+ 124 (with optional rule based direction of the otherwise automatic import/distribution process).

The designation “B+” is a shorthand reference for the corresponding designations of the multiple applications 124, i.e. application B, application C, application D, and so forth, installed in operating environment B 122.

The present invention contemplates that data associated with each of applications 104 and 124 include control data and user data. For the purpose of the present application, control data refers to data such as configuration or preference data, as well as other data of like kinds, that govern the operation of a particular installation of an application, whereas user data refers to the data created and/or consumed by a user of the application. For example, if the application is a word processing application, control data refers to data such as the default paper size and orientation, default paragraph and line formatting attributes, default font style and size, and other configuration/preference settings of the like, whereas user data are the documents created and editable using the word processing application.

Further, associated with each of applications 104 and 124 is one or more descriptors, e.g. descriptor A 106 for application A 104, and descriptors B+ 126 for applications B+ 124. Each descriptor describes at least one of (a) the criterion or criteria on which the presence of the application in an operating environment may be determined, (b) the exportable data of the application (also referred to as published data), and (c) the importable data of the application (also referred to as subscribed data). Moreover, as will be described in more details below, both the published data and the subscribed data are identified by the function/service to which the data are affiliated, referencing a cross application function/service based data classification model 120.

For ease of understanding, for the embodiment, application A 104, as an application having exportable data, is being illustrated with its descriptor A 106 as describing both the presence criteria and the publish data of the application. Similarly, applications B+ 106, as applications that will accept exported data, i.e. import data, their descriptors, descriptors B+ 116 are illustrated as describing both the presence criteria and the subscribed data of the application. However, for applications that publish as well as accept published data of other applications, their descriptors may describe both the published as well as the subscribed data. In sum, the present invention may be practiced with each of these three types of information separately described, or combinatorially described in part or in totality.

For the embodiment, application data exporter 108, as will be described in more detail below, is equipped to detect presence of application A 104 in operating environment 102, and export exportable data of application A 104, referencing descriptor A 106, and cross application function/service based data classification model 120. Further, the exported data are stored into datasets 110 that are organized in a function/service based manner.

In like manner, for the embodiment, application data importer/distributor 118 is equipped to detect presence of applications B+ 124 in operating environment B 122, and automatically import or distribute exported data stored in the function/service based datasets 110 into applications B+ 124, referencing descriptors B+ 126, and cross application function/service based data classification model 120. In one embodiment, the automatic import/distribution process is also subject to optional rule based direction, thereby permitting an owner, administrator, and/or user of environment B 122 to influence the otherwise automatic import/distribution process. In one embodiment, data importer/distributor 118 is advantageously organized in a modular fashion, having a number of function/service based data moving modules, with each of the data moving modules handling data of a corresponding function/service or data of a corresponding group of related functions/services.

Similar to descriptors 106 and 126, while for ease of understanding, application data exporter 108 and application data importer/distributor 118 are illustrated as separate entities, and separately described, it will be apparent from the description to follow, the present invention may be practiced with application data exporter 108 and application data importer/distributor 118 operating as a single entity.

Operating environments A and B 102 and 122 represent a broad range of operating environments known in the art, including but are not limited to the various operating environments of the various variants of the Windows Operating System available from Microsoft Corp. of Redmond, Wash., operating environments of the Linux operating systems, operating environments of the Palm operating system, and so forth. The two environments A and B 102 and 122 may be coupled to each other via removable medium, such as diskettes, CDROM, and the like, or via a direct high speed connection, such as a parallel interface, a Universal Serial Bus (USB) or IEEE 1394 based serial bus connection, or via a local or wide area network connection (LAN or WAN) going through a number of routers/switches and/or intermediate servers.

Exported data stored in datasets 110 and cross application function/service based data classification model 120 are illustrated as being disposed in both operating environments A and B 102 and 122, as they may be disposed in one environment, and made available to the other environment “remotely”, or they may be different copies respectively disposed in the two environments. In fact, the present invention may also be practiced with datasets 110 and model 120 disposed in one or more other environments, beside the data sourcing and data destination environments 102 and 122.

These and other aspects of the present invention will be described in terms in more detail below.

### Descriptors

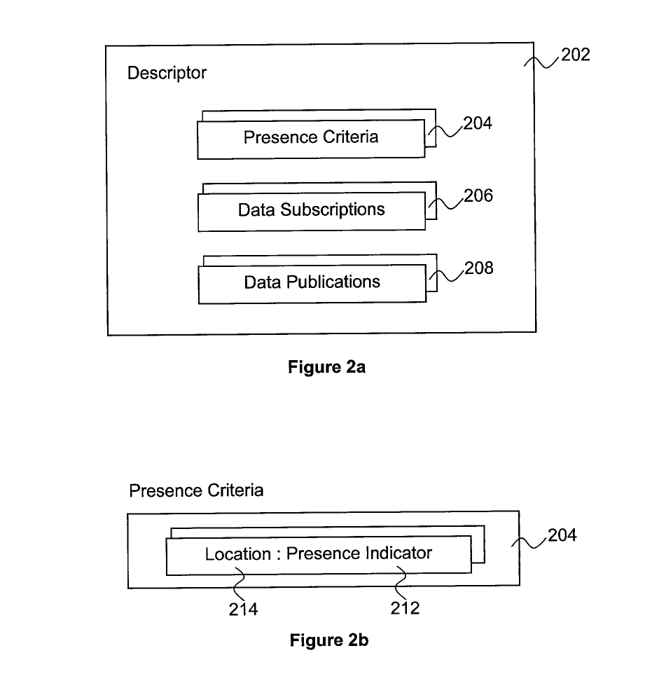

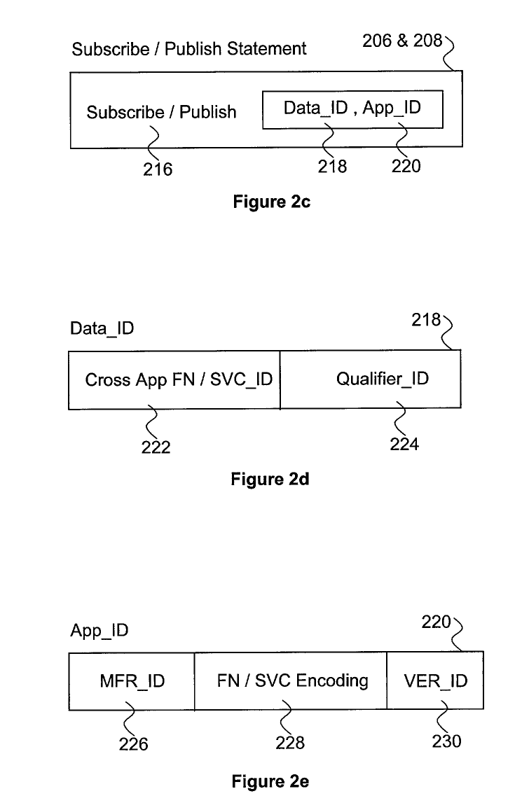

FIGS. 2a-2e illustrate an example one of descriptors 104 or 124 in further details, in accordance with one embodiment. For the embodiment, example descriptor 202 describes all three types of information of interest, i.e. the presence detection criteria, the published data, and the subscribed data. As illustrated in FIG. 2a, example descriptor 202 includes a number of presence detection criteria 204, a number of data subscription statements 206, and a number of data publication statements 208.

In one embodiment, as illustrated in FIG. 2b, each presence detection criteria 204 describes a presence indicator 212 and a location 214 in an operating environment where the presence indicator 212 may be found. In one embodiment, the information is expressed in using the Extended Markup Language (XML).

For example, for detecting the presence of the word processing application program Word2000 (available from Microsoft) in a Window'operating environment, presence criteria 204 may be expressed as follow:

<criterion type=“AND” not=“False”>

<registry key=“HKLM\Software\Microsoft Office” not=“False”/>
<file path=“C:\Program Files\Microsoft Office\\Office\WinWord.exe”

not=“False”/>

</criterion>

That is, the Word2000is to be deemed as having been installed in a Window operating environment, if the keywords “HKLM\Software\Microsoft Office” are found in the registry of the operating environment, and the executable “WinWord.exe” is found under a file system access path of “C:\Program Files\Microsoft Office\\Office\”. For the above example, the keyword “type=And” denotes the application is to be deemed as having been installed only if all the enumerated criteria are met. The employment of the clause “not=“false””, setting the working variable “not” to “false” to instruct a processing interpreter not to perform the logical NOT operation on the result of the evaluation of the leading criterion clause, is merely a computational technique to control the evaluation of the criterion. In alternate embodiments, “not=True” clauses or other evaluation control techniques, as well as other languages and/or conventions may also be employed to specify the presence indicators and locations, and control their evaluations.

In one embodiment, as illustrated in FIG. 2c, each subscription or publication statement 206 or 208 comprises a corresponding “subscribe” or “publish” keyword 216. Associated with the “subscribe”/“publish” keyword 216 are a pair of data and application identifiers 218 and 220. Data identifier 218 identifies the subscribe/publish data including the function/service to which the subscribe/publish data is associated with, whereas application identifier 220 identifies the publishing application of the data. In other words, in a subscription statement 206, application identifier 220 identifies the source application of the data, from which the subscribing application would accept the data, and in a publication statement 208, application identifier 220 identifies the application itself.

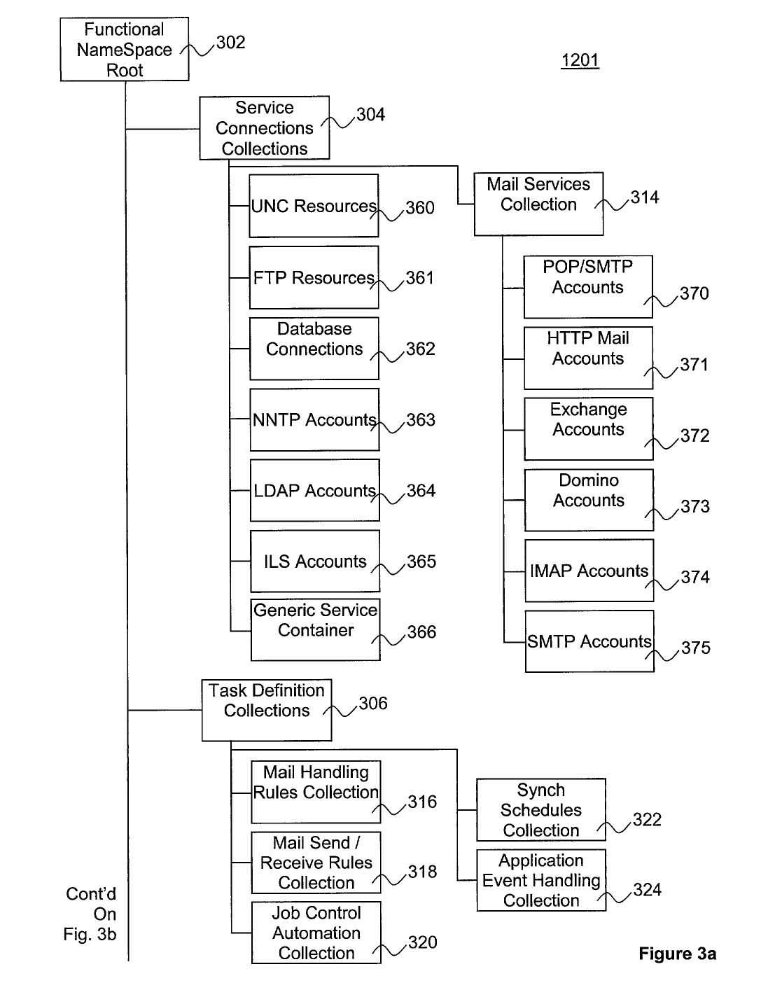

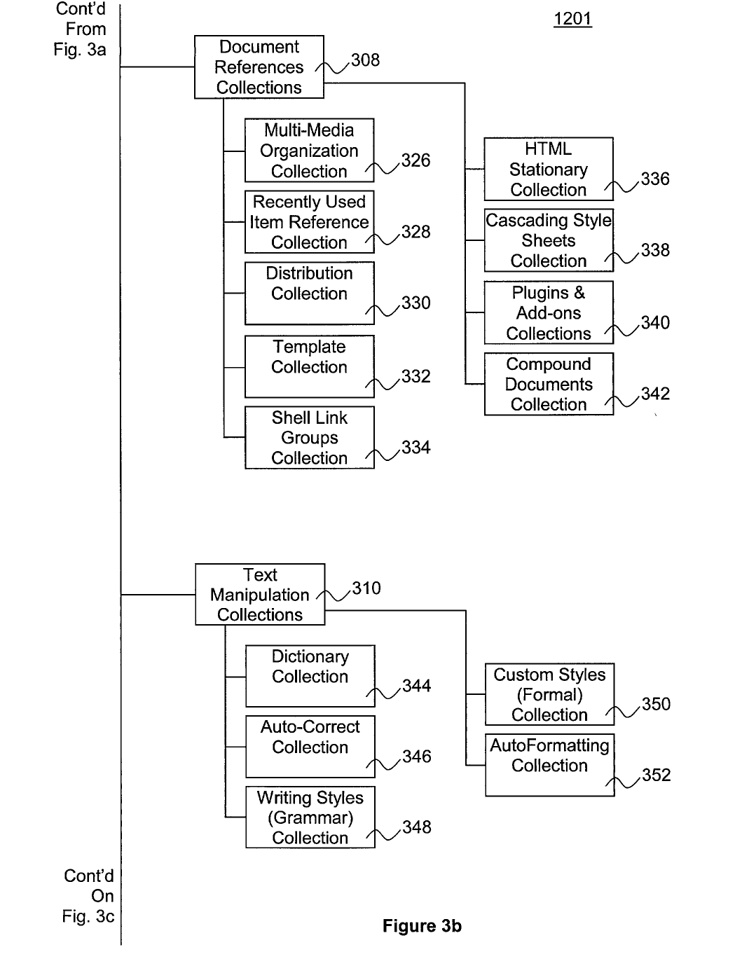

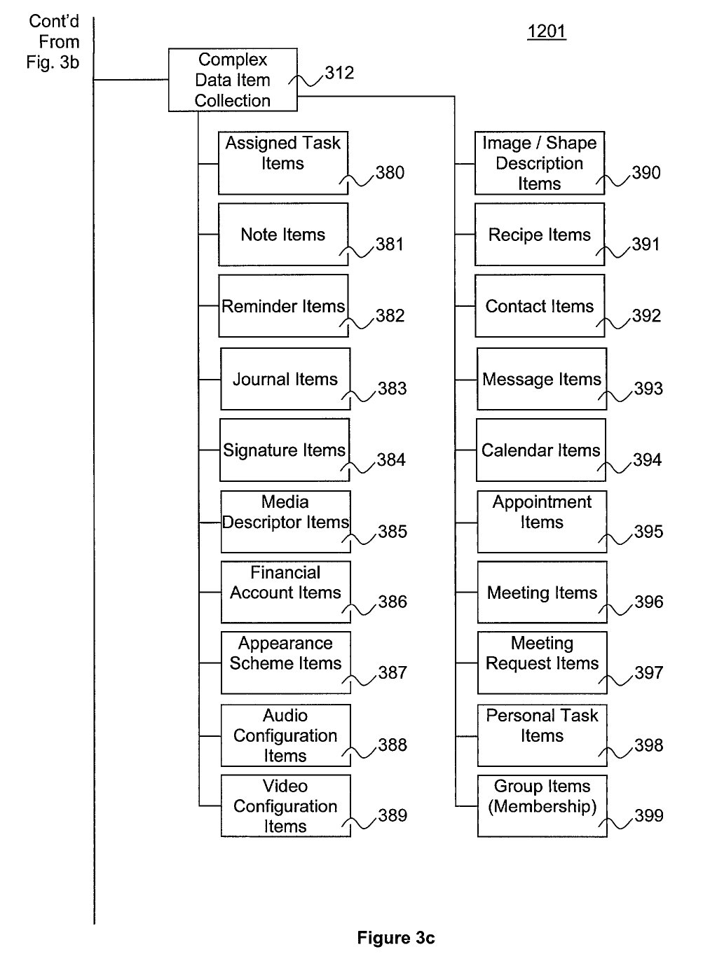

In one embodiment, as illustrated in FIG. 2d, data identification is effectuated by referencing a data item or a data type 222 in the earlier described cross application function/service based data classification model 120. As will be described in more detail below (referencing FIG. 3), in one embodiment, an enumerated data item or data type in cross application function/service based data classification model 120, not only identifies the data item/type by name, but also its characteristics and other attribute information. In one embodiment, the characteristic/attribute information includes in particular whether certain elements of the data type/item are “required”, “optional” or “source only”. Required elements refer to those elements whose presences are required for any actual data to be considered as having being an instance of the data item/type. Optional elements refer to those elements whose presences are optional in considering whether any actual data is an instance of the data item/type. Source only elements refer to those elements to be used by the source application of an instance of the data item/type only. Their presences in an instance of the data item/type should be ignored by a consumer of the data instance, unless the consumer has priori knowledge, and knows how to handle the elements.

For example, the “Contact” data item/type may be defined as having an email address element as a “required” element, first and last name elements as “optional” elements, and a web address element as a “source only” element. Such “Contact” data item/type having the aforesaid and other elements may be expressed for the function/service based data classification model, using XML, in the following manner:

<DataItemType Name=“Contact”>
<ItemID=54456600/>

| | |
|---|---|
| <Email1=“Jaya@Detto.com” required=1 /> | Required |
| <FirstName=“Jay” required=0 /> | Optional |
| <LastName=“Anderson” required=0 /> | Optional |
| <Title=“Director - Applications Analysis” required=0 /> | Optional |
| <BusinessPhone=“425-201-4930” required=0 /> | Optional |
| <Company=“Detto Technologies, Inc” required=0 /> | Optional |
| <PropertyList Count=1> | |
| <Property> | Source Only |
| <Name=“WebAddress”/> | |
| <Value=“http://www.detto.com”/> | |
| </Property> | |
| </PropertyList> | |
| </DataItemType> | |

In one embodiment, a data item/type may also be subdivided into sub-item/sub-type, reference to data item/type of model 120 may further be qualified and narrowed to a sub-item/type through qualifier identifier 204. For example, a “Connection” data item/type may have a a number of “Connection” sub-item/type, SMTP, POP, and so forth. A qualifier identifier 204, thus allows an application to specify interest in a specific connection type. Qualifier identifier 204 may be specified using any convenient encoding convention.

Note that the provision of qualifier identifier 204 advantageously allows the burden of data selection to be flexibly placed on either e.g. the portion of a data moving module responsible for retrieving the data from a function/service based dataset (when a qualifier identifier is specified in conjunction with a data item/type request) or a portion of a data moving module responsible for importing/distributing the data (when the qualifier identifier is not specified in conjunction with the data item/type request).

In one embodiment, application identifier 220 includes a manufacturer identifier 226 identifying the manufacturer of the application, e.g. Microsoft, function/service encoding 228 identifying the functions/services provided by the application, and a version identifier 230 identifying the version of the application, e.g. 0xFFFF for version 1, oxFFFE for version 2, and so forth. In various embodiments, function/service encoding 228 is a binary bit vector with each bit representing an “essential” function/service (for function/service matching purpose), and the bit is set to “1“if the “essential” function/service (for function/service matching purpose) is provided by the application. The length of the binary bit vector encoding and the semantic of each bit are implementation dependent, and may vary for different embodiments.

For example, in an exemplary 16-bit function/service encoding, the semantic of the individual bits may be set as follows:

| Bit | |
|---|---|
| Position | Function/Service |
| 16 | Handles Application Profiles |
| 15 | Handles Mail Data |
| 14 | Handles Contact Data |
| 13 | Handles Browsing |
| 12 | Handles Service Connection Data |
| 11 | Handles Appointment Data |
| 10 | Handles Calendar Data |
| 9 | Handles Journal Data |
| 8 | Handles Task Item Data |
| 7 | Handles Task Definition Data |
| 6 | Handles News Post Data |
| 5 | Handles Audio\Video Settings |
| 4 | Reserved |
| 3 | |
| 2 | |
| 1 | |

Obviously, the longer the binary bit vector encoding is, the more the number of functions/services may be represented. In one embodiment, the binary bit vector encoding is 128 bits long, representing 128-n “essential” functions/services (for function/service matching purpose), where n are n reserved bits for used to uniquely encode a product, to ensure distinctions between products having identical offerings for the “essential” functions/services.

Referring back to FIG. 2a, in one embodiment, example descriptor 202 is also employed to specify the processing rules to be applied during data extraction and/or data import/distribution. The specification may be explicit using e.g. XML statements, or may be implicit, referencing e.g. a rule file.

### Cross Application Function/Service Based Data Classification Model

FIGS. 3a-3c illustrate a portion of an example implementation of cross application function/service based data classification model 120 of FIG. 1. The example implementation is illustrated in part, so not to obscure the present invention, and enables better understanding the key principles. The illustrated portion illustrates data items/types commonly found in mail, personal information management, and other applications of the like. The data items/types are defined, organized and classified by the functions/services to which the data items/types are associated.

More specifically, for the illustrated portion, example model 120′ includes root node 302, a number of first level data item/type collections 304-312, and a number of second level data item/type collections 314-352. Further, first and second level data item/type collections 304, 312 and 314 include data items/types 360-366, 370-375 and 380-399 of the various collections.

First level data item/type collections 304-312 include service connection collections 304, task definition collections 306, document reference collections 308, text manipulation collections 310, and complex data item collection 312.

Service connection collections 304 includes the data items/types of UNC resource item/type 360, FTP resource item/type 361, database connection item/type 361, NNTP account item/type 363, LDAP account item/type 364, ILS account item/type 365, generic service container item/type 366, and mail service collection 314, which includes POP/SMTP account item/type 370, HTTP mail account item/type 371, Exchange account item/type 372, Domino account item/type 373, IMAP account item/type 374 and SMTP account item/type 375.

Complex data item collection 312 includes assigned task item/type 380, note item/type 381, reminder item/type, 382, journal item/type 383, signature item/type 384, media descriptor item/type 385, financial account item/type 386, appearance scheme item/type 387, audio configuration item/type 388, video configuration item/type 389, image/shape descriptor item/type 390, recipe item/type 391, contact item/type 392, message item/type 393, calendar item/type 394, appointment item/type 395, meeting item/type 396, meeting request item/type 397, personal task item/type 398 and group membership item/type 399.

Each of these data item/type 360-366, 370-375 and 380-399 defines at least the data characteristics and optionally, other attributes of the data item/type. See the earlier described “contact” data item/type example.

Each of these data item/type 360-366, 370-375 and 380-399 is referenced by the earlier described data identifier. For example, the following exemplary data items may be assigned with data identifiers as follows:

| Data Item/Type | Data Identifier* |
|---|---|
| Favorites/BookMarks Items | {0001} |
| Cookie Items | {0002} |
| History Items | {0003} |
| Service Connections | {0004} |
| Security Setting Items | {0005} |
| Security Certificate Items | {0006} |
| Data Display Setting Items | {0007} |
| Email Items | {0008} |
| E-Mail Signature Items | {0009} |
| Task Definition Items | {000A} |
| NewsPost Items | {000B} |
| News Groups Items | {000C} |
| Post Signature Items | (000D} |
| Contact Info Items | {000E} |
| Calendar Items | {000F} |
| Appointment Items | {0010} |
| Journal Items | {0011} |
| Task Items | {0012} |
| Audio/Video Settings Items | {0013} |
| Files Received Repository Items | {0014} |
| Act! 2002 Application Specific Data | {0015} |
| Internet Explorer 5.0 App Specific Data | {0016} |
| Internet Explorer 5.5 App Specific Data | {0017} |
| Netmeeting Application Specific Data | {0018} |
| Netscape Messenger App Spec Data | {0019} |
| Netscape Navigator App Specific Data | {001A} |
| Netscape News Reader App Spec Data | {001B} |
| Opera 3 App Specific Data | {001C} |
| Outlook Express 5.5 App Specific Data | {001D} |

*Recall as described earlier, on usage, each data identifier may be further qualified by a corresponding qualifier identifier to select a subset of the sub-items associated with the referenced data item/type.

The above example implementation of cross application function/service based data classification model 120′, as will be readily apparent from the description to follow, is instrumental in facilitating efficient export and import/distribution of data among mail, personal information management and other applications of the like. The implementation may be extended and/or modified to support more or less data items/types, including data items/types of applications of other kinds.

### Data Export

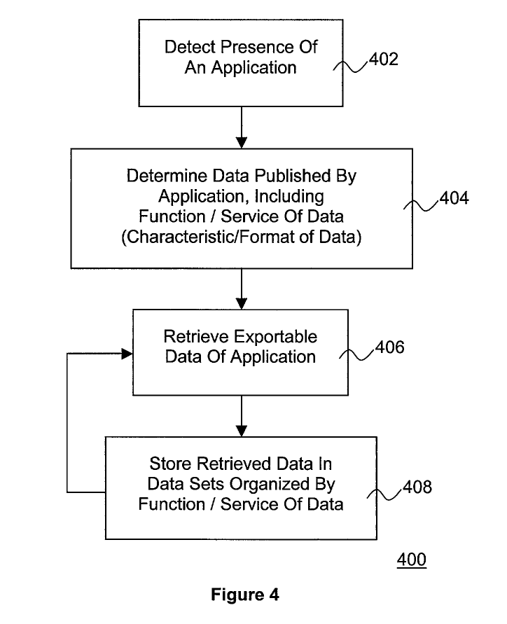

FIG. 4 illustrates the operational flow of the relevant aspects of data exporter 108, in accordance with one embodiment. As described earlier, data exporter 108 is equipped to export exportable data of an application in a function/service based manner, referencing preferentially the application's descriptor, and the cross application function/service based data classification model of the present invention.

Accordingly, upon invocation, for the embodiment, data exporter 108 determines the presence of an application of interest, block 402. That is, for the earlier described embodiment including the descriptor feature, data exporter 108 accesses the (presence) descriptor of the application, retrieves the presence criteria or conditions, and accesses the presence indicators at the locations specified by the presence criteria to confirm whether the application of interest is indeed present in the operating environment. The application of interest may be specified to data exporter 108 via any one of a number of input techniques known in the art, e.g. through an input prompt offered by data exporter 108, through an input file of a predetermined name, or implicitly through the identification of the application's (presence) descriptor to data exporter 108, and so forth.

Upon confirming the presence of the application of interest, data exporter 108 determines the exportable data of the application, including the functions/services affiliations of the exportable data, block 404. For the earlier described embodiment, data exporter 108 accesses the (data publication) descriptor of the application, retrieves the data publication statements, and examines the published data specified, referencing the cross application function/service based data classification model for function/service affiliation and data format/attribute information.

Upon identifying the exportable data, including their functions/services affiliation and format/attribute information, data exporter 108 retrieves the exportable data of the application, block 406. Recall from earlier description, the data may include control as well as user data. The control data may be retrieved from the registry of the operating environment, and/or configuration/preference files of the application (through API calls where available) and the user data may be retrieved from databases or files of the application from applicable database or file subsystems.

Upon retrieving the data, or more typically as the data are retrieved, for the embodiment, the data are stored into datasets that are organized by the function/service affiliations of the data, block 408. That is, service connection data items are stored in a service connection dataset, mail service data items are stored in a mail service dataset, and so forth.

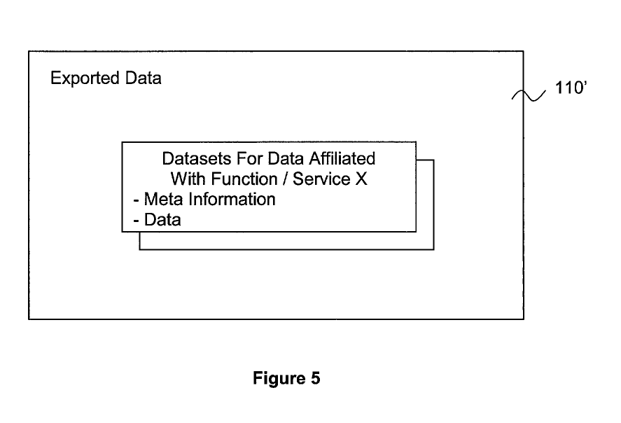

In one embodiment, the first storage of data into a function/service based dataset 110 also includes the storing of meta information describing the data being stored. In one embodiment, the meta information also includes identification information of the publishing application. In one embodiment, as illustrated in FIG. 5, the meta information is advantageously encoded in the form of the earlier described data identifier 218 and application identifier 220 of FIGS. 2d and 2e.

### Data Import or Distribution

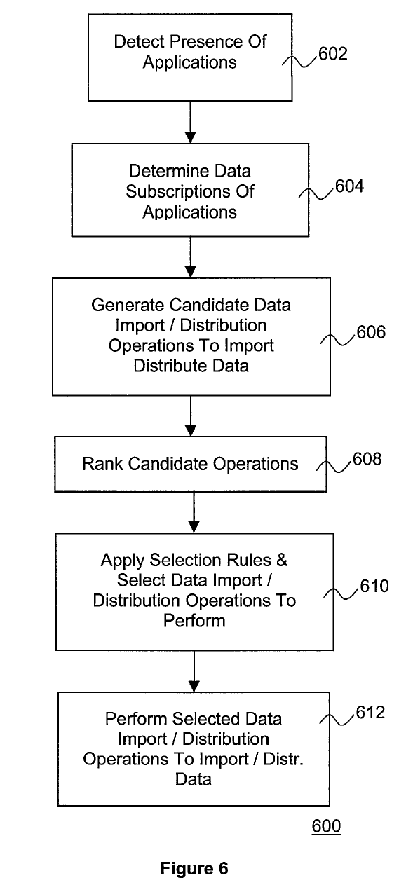

FIG. 6 illustrates the operational flow of the relevant aspects of data importer/distributor 118, in accordance with one embodiment. As described earlier, data importer/distributor 118 is equipped to automatically import or distribute exported data of one or more applications, stored in a function/service based manner, with optional rule based direction of the otherwise automatic import/distribution process, referencing preferentially the applications' descriptors, and the cross application function/service based data classification model of the present invention.

Accordingly, upon invocation, for the embodiment, data importer/distributor 108 determines the presence of potential recipient applications, block 602. That is, for the earlier described embodiment including the descriptor feature, data importer/distributor 118 accesses the (presence) descriptors of the applications, retrieves the presence criteria or conditions, and accesses the presence indicators at the locations specified by the presence criteria to confirm whether the applications are indeed present in the operating environment. Similarly, the potential recipient applications may be specified to data importer/distributor 118 via any one of a number of input techniques known in the art, including implicit specification through the identification of their descriptors to data importer/distributor 118.

Upon confirming the presence of the potential recipient applications, data importer/distributor 108 determines the data subscribed by the applications, including the function/service affiliations of the subscribed data, block 604. Similarly, for the earlier described embodiment, data importer/distributor 118 accesses the (data subscription) descriptor of the application, retrieves the data subscription statements, and examines the subscribed data specified, referencing the cross application function/service based data classification model for function/service affiliation and data format/attribute information.

Upon identifying each of the subscribed data of the potential recipient applications, including its function/service affiliation and format/attribute information, data importer/distributor 108 generates a candidate data import/distribution operation. In one embodiment, the candidate data import/distribution operation identifies the data, its function/service affiliation, the data moving module of data importer/distributor 108 to perform the operation, the function/service based dataset from which the data are to be retrieved, and the recipient application.

Upon generating all the candidate data import/distribution operations, data importer/distributor 118 performs a number of ranking operations on the candidate data import/distribution operations. In one embodiment, if the publishing application and potential recipient application are different versions of the same application, data importer/distributor 118 performs a version ranking operation on the candidate data import/distribution operation. If they are not, i.e. they are different applications, data importer/distributor 118 performs a function/service matching ranking operation on the candidate data import/distribution operation.

In one embodiment, the version ranking operation is performed, by performing a predetermined arithmetic operation on the version information in the application identifier of the potential recipient application. More specifically, in one embodiment where the older versions are encoded with higher decimal value encoding, the arithmetic operation is performed in the following manner:

(Maximum Version+1)−(value of the Version ID field of the proposed recipient application).

Thus, for the earlier example, where version 1 is encoded as 0xFFFF, version 2 is encoded as 0xFFFE, and so forth, the version ranking for a candidate operation to move the data to a version 2 installation of the application is 0x0002, whereas the version ranking for a candidate operation to move the data to a version 3 installation of the application is 0x0003. In one embodiment, the function/service matching ranking operation is performed, by performing a predetermined Boolean operation on the function/service information in the application identifiers of the respective applications. More specifically, in one embodiment, the Boolean operation is the logical AND operation of the binary bit vector function/service encoding of the respective applications. The resulting ranking is the number of 1-bit in the resulting bit vector of the logical AND operation, determined e.g. through a union operation on the resulting bit vector of the logical AND operation.

In one embodiment where a candidate operation that moves data from one version of an application to another version of the same application is ranked by the earlier described version ranking operation, to facilitate such candidate operation to be ranked against candidate operations that move data to different applications, where the latter type of candidate operations are ranked by the earlier described function/service ranking operation, the rank of a version ranked candidate operation is left shifted. For example, if the rank of a version ranked candidate operation is “0x0001”, it is left shifted to become “0x00010000”.

Continuing to refer to FIG. 6, for the embodiment, upon ranking the candidate data import/distribution operations, data importer/distributor 118 apply one or more selection rules to select all or a subset of the candidate data import/distribution operations to perform, block 610. In other words, under the present invention, exported data, such as contact information, subject to the selection rules, may be advantageously imported or distributed to one or more recipient applications.

In one embodiment, the selection rules include constant selection rules as well as variable or user modifiable selection rules. Constant selection rules are those rules that do not involve dynamic qualification of the rules by users, through e.g. user inputs, whereas variable or user modifiable selection rules are selection rules that involve dynamic qualification of the rules by users, through e.g. user inputs.

An example of a constant selection rule if a rule that specifies the highest ranked candidate data import/distribution operation for each function/service based dataset is to be performed. An example of a variable selection rule is a rule that specifies a range of ranking for the candidate data import/distribution operation for each function/service based dataset.

The selection rules may be expressed in any conventional rule expression techniques, including but are not limited to the employment of a XML-like language; and similarly, the selection rules may be provided to data importer/distributor 118 via any one of a number of conventional techniques, including but are not limited to the employment of an input rule file.

Still referring to FIG. 6, upon applying the selection rules (including user inputs), and selected the candidate data import/distribution operations to be performed, data importer/distributor 118 perform the selected data import/distribution operations, importing/distributing the exported data from the appropriate function/service based datasets to the identified recipient applications of the selected operations, block 612.

Accordingly, under the present invention, data may be efficiently moved from one application to another, from one application to n other applications (n>1), from m applications to one application (m>1), or from m applications to n applications.

### Example Computer System

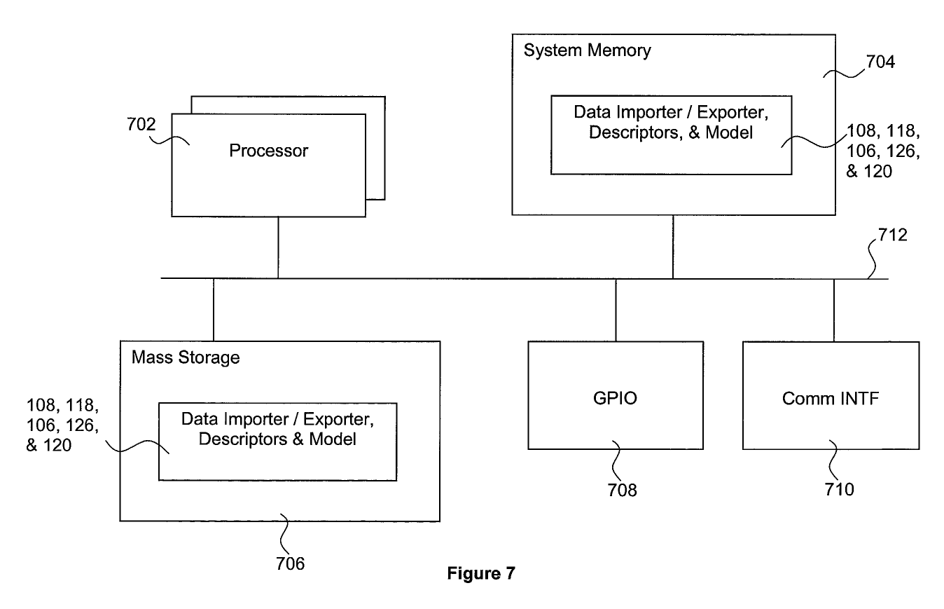

FIG. 7 illustrates an example computer system suitable for use to practice the present invention in accordance with one embodiment. As shown, computer system 700 includes one or more processors 702 and system memory 704. Additionally, computer system 700 includes mass storage devices 706 (such as diskette, hard drive, CDROM and so forth), general purpose input/output interface 708 (for interfacing input/output devices such as keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, system memory 704 and mass storage 706 are employed to store a working copy and a permanent copy of the programming instructions implementing the earlier described data exporter/importer, function/service based data classification model, and application descriptors of the present invention. The permanent copy of the programming instructions may be loaded into mass storage 706 in the factory, or in the field, through a distribution medium (not shown) or through communication interface 710 (from a distribution server (not shown)).

The constitution of these elements 702-712 are known, and accordingly will not be further described.

As alluded to earlier, computing system 700 may be a wireless mobile phone, a palm sized personal digital assistant, a notebook computer, a desktop computer, a set-top boxe, a game console, a server, and so forth.

### Conclusion and Epilog

Thus, it can be seen from the above description, a method and apparatus for exporting data from one or more applications, and automatically importing/distributing the exported data to one or more other applications (with optional rule based direction to the otherwise automatic import/distribution process) has been described. While the present invention has been described in terms of the above illustrated embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A machine implemented method of operation comprising
determining if a first application provides a first function/service to which first data stored in a first data set are associated; and
if so, generating a first candidate operation that distributes said first data stored in said first data set into said first application for performance consideration.

2. The method of claim 1, wherein said determining comprises examining a plurality of data subscription statements of said first application, and determining if any of the data subscription statements specifies said first application as being a subscriber of data associated with said first function/service.

3. The method of claim 2, wherein function/service to which said data subscribed to by said first application are associated, as well as function/service to which said first data stored in said first dataset are associated, are both expressed in term of a first cross application function/service classification of a cross application function/service based data classification model.

4. The method of claim 3, wherein said first cross application function/service classification is in a form of an encoded binary representation.

5. The method of claim 2, wherein the method further comprises retrieving said data subscription statements of said first application.

6. The method of claim 5, wherein said retrieving of the data subscription statements of the first application comprises retrieving the data subscription statements from a desriptor of the first application.

7. The method of claim 1, wherein the method further comprises
determining if a second application also provides said first function/service to which said first data stored in said first data set are associated; and
if so, generating a second candidate operation that distributes said first data stored in said first data set into said second application for performance consideration.

8. The method of claim 7, wherein if both said first and second candidate operations are generated, the method further comprises
generating first and second rankings for said first and second candidate operations; and
selecting at least one of said first or said second candidate operations for performance, based at least in part on said first and second rankings of said first and second candidate operations.

9. The method of claim 8, wherein said first data stored in said first dataset is published by a third application, with said first/second application being a different version of said third application, said generating of the first/second ranking for said first/second candidate operation comprises generating a first/second version ranking for said first/second candidate operation that favors a later version over an earlier version.

10. The method of claim 9, wherein said first, second and third applications are identifed by first, second and third application identifiers comprising first, second and third version information, and said generating of first/second version ranking comprises performing a predetermined arithmetic operation on said first/second binary application identifier with said third binary application identifer that yields a higher verion ranking for a later version.

11. The method of claim 8, wherein said first data stored in said first dataset is published by a third application, with said first/second and third applications being different applications, said generating of the first/second ranking for said first/second candidate operation comprises generating a first/second function ranking for said first/second candidate operation that favors an application having more function/service matches with said third application over an application having less function/service matches with said third application.

12. The method of claim 11, wherein said first, second and third applications are identifed by first, second and third application identifiers comprising first, second and third function/service information encoded in a binary form, and said generating of first/second function/service ranking comprises performing at least a predetermined boolean operation on said first/second function/service information encoded in binary form with said third function/service information encoded in binary form that yields a higher function/service ranking for an application with closer function/service matches.

13. The method of claim 8, wherein said selecting of at least one of said first and said second candidate operations for performance is further based on one or more selection rules.

14. The method of claim 13, wherein said one or more selection rules comprise one or more constant select rules.

15. The method of claim 14, wherein said one or more constant select rules comprise a first constant selection rule that selects the candidate operation with the highest ranking for performance.

16. The method of claim 13, wherein said one or more selection rules comprise one or more variable selection rules that variably selects one or more candidate operations based on user input.

17. The method of claim 1, wherein the method further comprises
determining if said first application provides a second function/service to which second data stored in a second data set are associated; and
if so, generating a second candidate operation that distributes said second data stored in said second data set into said first application for performance consideration.

18. The method of claim 1, wherein said first data comprises control data usable to control operation of said first application.

19. The method of claim 1, wherein said first data comprises user data consumable using said first application.

20. The method of claim 1, wherein the method further comprises discovering presence of said first application.

21. The method of claim 20, wherein said discovering comprises
retrieving a plurality of presence criteria of said first application; and
determining if the presence criteria are met.

22. The method of claim 21, wherein said retrieving comprises retrieving said plurality of presence criteria from a desriptor of said first application.

23. The method of claim 21, wherein said determining if the presence criteria are met comprises accessing a registry of an operating environment within which said first application is installed to verify if said presence criteria are met.

24. A machine implemented method of operation comprising
generating a first ranking for a first candidate operation to distribute data stored in a dataset, exported from a first application, to a second application;
generating a second ranking for a second candidate operation to distribute said data stored in said dataset, exported from said first application, to a third application; and
selecting one or both of said first and second candidate operations for performance, based at least in part on said generated first and second rankings.

25. The method of claim 24, wherein said second/third application is a different version of said first application, said generating of the first/second ranking for said first/second candidate operation comprises generating a first/second version ranking for said first/second candidate operation that favors a later version over an earlier version.

26. The method of claim 25, wherein said first, second and third applications are identifed by first, second and third application identifiers comprising first, second and third version infromation, and said generating of first/second version ranking comprises performing a predetermined arithmetic operation on said second/third version information with said first version information that yields a higher verion ranking for a later version.

27. The method of claim 24, wherein said first and said second/third applications are different applications, said generating of the first/second ranking for said first/second candidate operation comprises generating a first/second function ranking for said first/second candidate operation that favors an application having more function/service matches with said first application over an application having less function/service matches with said first application.

28. The method of claim 27, wherein said first, second and third applications are identifed by first, second and third application identifiers comprising first, second and third function/service information encoded in a binary form, and said generating of first/second function/service ranking comprises performing a predetermined boolean operation on said first function/service information encoded in binary form with said second/third function/service information encoded in binary form that yields a higher function/service ranking for an application with closer function/service matches.

29. The method of claim 24, wherein said selecting of at least one of said first and said second candidate operations for performance is further based one or more selection rules.

30. The method of claim 29, wherein said one or more selection rules comprise one or more constant select rules.

31. The method of claim 30, wherein said one or more constant select rules comprise a first constant selection rule that selects the candidate operation with the highest ranking for performance.

32. The method of claim 29, wherein said one or more selection rules comprise one or more variable selection rules that variably selects one or more candidate operations based on user input.

33. A machine implemented method of operation comprising
retrieving a plurality of data subscription statements of an application;
determining importable data of said application based on data subscription specifications of said data subscription statements; and
importing said importable data of said application, based at least in part on said data subscription specification of said data subscription statements of said application.

34. The method of claim 33, wherein said retrieving of the data subscription statements of the application comprises retrieving the data subscription statements from a desriptor of the application.

35. The method of claim 33, wherein said data subscription specifications reference data having cross application function/service based classifications of a cross application function/service based data classification model.

36. The method of claim 35, wherein said data subscription spefications comprise encoded binary references referencing said data having having cross application function/service based classifications of a cross application function/service based data classification model.

37. The method of claim 33, wherein the method further comprises discovering presence of said application.

38. The method of claim 37, wherein said discovering comprises
retrieving a plurality of presence criteria of said application; and
determining if the presence criteria are met.

39. The method of claim 38, wherein said retrieving comprises retrieving said plurality of presence criteria from a desriptor of said application.

40. The method of claim 38, wherein said determining if the presence criteria are met comprises accessing a registry of an operating environment within which said application is installed to verify if said presence criteria are met.

41. A machine implemented method of operation comprising
retrieving a plurality of presence criteria of an application;
determining if the presence criteria are met;
if so, further determining importable data of said application; and
importing said importable data of said application.

42. The method of claim 41, wherein said retrieving comprises retrieving said plurality of presence criteria from a desriptor of said application.

43. The method of claim 41, wherein said determining if the presence criteria are met comprises accessing a registry of an operating environment within which said application is installed to verify if said presence criteria are met.

44. An article of manufacture comprising:
a storage medium comprising a recordable medium; and
a plurality of machine readable programming instructions recorded on said recordable medium of said storage medium, designed to program an apparatus to enable the apparatus to
determine if a first application provides a first function/service to which first data stored in a first data set are associated, and
if so, generate a first candidate operation that distributes said first data stored in said first data set into said first application for performance consideration.

45. The article of claim 44, wherein said programming instructions are designed to enable the apparatus to perform said determining by examining a plurality of data subscription statements of said first application, and determining if any of the data subscription statements specifies said first application as being a subscriber of data associated with said first function/service.

46. The artcile of claim 45, wherein function/service to which said data subscribed to by said first application are associated, as well as function/service to which said first data stored in said first dataset are associated, are both expressed in term of a first cross application function/service classification of a cross application function/service based data classification model.

47. The article of claim 46, wherein said first cross application function/service classification is in a form of an encoded binary representation.

48. The article of claim 45, wherein said programming instructions are further designed to enable the apparatus to retrieve said data subscription statements of said first application.

49. The article of claim 48, wherein said programming instructions are designed to enable the apparatus to perform said retrieving of the data subscription statements of the first application by retrieving the data subscription statements from a desriptor of the first application.

50. The article of claim 44, wherein said programming instructions are further designed to enable the apparatus to
determine if a second application also provides said first function/service to which said first data stored in said first data set are associated; and
if so, generate a second candidate operation that distributes said first data stored in said first data set into said second application for performance consideration.

51. The artcile of claim 50, wherein said programming instructions are further designed to enable the apparatus to
generate first and second rankings for said first and second candidate operations, and
select at least one of said first or said second candidate operations for performance, based at least in part on said first and second rankings of said first and second candidate operations,
if both said first and second candidate operations are generated.

52. The article of claim 51, wherein said programming instructions are further designed to enable the apparatus to perform said generating of the first/second ranking for said first/second candidate operation by generating a first/second version ranking for said first/second candidate operation that favors a later version over an earlier version, when said first data stored in said first dataset is published by a third application, and said first/second application being a different version of said third application.

53. The article of claim 52, wherein said programming instructions are further designed to enable the apparatus to perform said generating of first/second version ranking by performing a predetermined arithmetic operation on said first/second binary application identifier with said third binary application identifer that yields a higher verion ranking for a later version, when said first, second and third applications are identifed by first, second and third application identifiers comprising first, second and third version infromation.

54. The article of claim 51, wherein said programming instructions are further designed to enable the apparatus to perform said generating of the first/second ranking for said first/second candidate operation by generating a first/second function ranking for said first/second candidate operation that favors an application having more function/service matches with said third application over an application having less function/service matches with said third application, when said first data stored in said first dataset is published by a third application, and said first/second and third applications are different applications.

55. The article of claim 54, wherein said programming instructions are further designed to enable the apparatus to perform said generating of first/second function/service ranking by performing at least a predetermined boolean operation on said first/second function/service information encoded in binary form with said third function/service information encoded in binary form that yields a higher function/service ranking for an application with closer function/service matches, when said first, second and third applications are identifed by first, second and third application identifiers comprising first, second and third function/service information encoded in a binary form.

56. The article of claim 51, wherein said programming instructions are further designed to enable the apparatus to further base said selecting of at least one of said first and said second candidate operations for performance, on one or more selection rules.

57. The article of claim 56, wherein said one or more selection rules comprise one or more constant select rules.

58. The article of claim 57, wherein said one or more constant select rules comprise a first constant selection rule that selects the candidate operation with the highest ranking for performance.

59. The article of claim 56, wherein said one or more selection rules comprise one or more variable selection rules that variably selects one or more candidate operations based on user input.

60. The article of claim 44, wherein said programming instructions are further designed to enable the apparatus to
determine if said first application provides a second function/service to which second data stored in a second data set are associated, and
if so, generating a second candidate operation that distributes said second data stored in said second data set into said first application for performance consideration.

61. The article of claim 44, wherein said first data comprises control data usable to control operation of said first application.

62. The article of claim 44, wherein said first data comprises user data consumable using said first application.

63. The article of claim 44, wherein said programming instructions are further designed to enable the apparatus to discover presence of said first application.

64. The article of claim 63, wherein s said programming instructions are further designed to enable the apparatus to perform said discovering by
retrieving a plurality of presence criteria of said first application, and
determining if the presence criteria are met.

65. The article of claim 64, wherein said programming instructions are further designed to enable the apparatus to perform said retrieving by retrieving said plurality of presence criteria from a desriptor of said first application.

66. The article of claim 64, wherein said programming instructions are further designed to enable the apparatus to perform said determining if the presence criteria are met by accessing a registry of an operating environment within which said first application is installed to verify if said presence criteria are met.

67. The article of claim 44, wherein said article and said apparatus are one of the same, and said article/apparatus further comprises at least one processor coupled to the storage medium to execute the programming instructions.

68. The article of claim 67, wherein said article/apparatus is a selected one of a wireless mobile phone, a palm sized computing device, a notebook sized computing device, a desktop computing device, a set-top box and a server.

69. A article of manufacture comprising
a storage medium having a recordable medium; and
a plurality of machine readable programming instructions recorded on said recordable medium of said storage medium, designed to program an apparatus to enable the apparatus to
generate a first ranking for a first candidate operation to distribute data stored in a dataset, exported from a first application, to a second application,
generate a second ranking for a second candidate operation to distribute said data stored in said dataset, exported from said first application, to a third application, and
select one or both of said first and second candidate operations for performance, based at least in part on said generated first and second rankings.

70. The article of claim 69, wherein said programming instructions are designed to enable said apparatus to perform said generating of the first/second ranking for said first/second candidate operation by generating a first/second version ranking for said first/second candidate operation that favors a later version over an earlier version, when said second/third application is a different version of said first application.

71. The article of claim 70, wherein said programming instructions are designed to enable said apparatus to perform said generating of first/second version ranking comprises performing a predetermined arithmetic operation on said second/third version information with said first version information that yields a higher verion ranking for a later version, when said first, second and third applications are identifed by first, second and third application identifiers comprising first, second and third version infromation.

72. The article of claim 69, wherein said programming instructions are designed to enable said apparatus to perform said generating of the first/second ranking for said first/second candidate operation comprises generating a first/second function ranking for said first/second candidate operation that favors an application having more function/service matches with said first application over an application having less function/service matches with said first application, when said first and said second/third applications are different applications.

73. The article of claim 72, wherein said programming instructions are designed to enable said apparatus to perform said generating of first/second function/service ranking comprises performing a predetermined boolean operation on said first function/service information encoded in binary form with said second/third function/service information encoded in binary form that yields a higher function/service ranking for an application with closer function/service matches, when said first, second and third applications are identifed by first, second and third application identifiers comprising first, second and third function/service information encoded in a binary form.

74. The artcile of claim 69, wherein said programming instructions are designed to enable said apparatus to further based said selecting of at least one of said first and said second candidate operations for performance, on one or more selection rules.

75. The article of claim 74, wherein said one or more selection rules comprise one or more constant select rules.

76. The article of claim 75, wherein said one or more constant select rules comprise a first constant selection rule that selects the candidate operation with the highest ranking for performance.

77. The article of claim 74, wherein said one or more selection rules comprise one or more variable selection rules that variably selects one or more candidate operations based on user input.

78. The article of claim 69, wherein said article and said apparatus are one of the same, and said article/apparatus further comprises at least one processor coupled to the storage medium to execute the programming instructions.

79. The article of claim 78, wherein said article/apparatus is a selected one of a wireless mobile phone, a palm sized computing device, a notebook sized computing device, a desktop computing device, a set-top box and a server.

80. An article of manufacture comprising
a storage medium having a recordable medium; and
a plurality of machine readable programming instructions recorded on said recordable medium of said storage medium, designed to program an apparatus to enable the apparatus to
retrieve a plurality of data subscription statements of an application,
determine importable data of said application based on data subscription specifications of said data subscription statements, and
import said importable data of said application, based at least in part on said data subscription specification of said data subscription statements of said application.

81. The article of claim 80, wherein said programming instructions are designed to enable the apparatus to perform said retrieving of the data subscription statements of the application by retrieving the data subscription statements from a desriptor of the application.

82. The article of claim 80, wherein said data subscription specifications reference data having cross application function/service based classifications of a cross application function/service based data classification model.

83. The article of claim 82, wherein said data subscription spefications comprise encoded binary references referencing said data having having cross application function/service based classifications of a cross application function/service based data classification model.

84. The article of claim 80, wherein said programming instructions are further designed to enable the apparatus to discover presence of said application.

85. The article of claim 84, wherein said programming instructions are designed to enable the apparatus to perform said discovering by
retrieving a plurality of presence criteria of said application; and
determining if the presence criteria are met.

86. . The article of claim 85, wherein said programming instructions are designed to enable the apparatus to perfrom said retrieving by retrieving said plurality of presence criteria from a desriptor of said application.

87. The article of claim 85, wherein said programming instructions are designed to enable the apparatus to perform said determining if the presence criteria are met by accessing a registry of an operating environment within which said application is installed to verify if said presence criteria are met.

88. The article of claim 80, wherein said article and said apparatus are one of the same, and said article/apparatus further comprises at least one processor coupled to the storage medium to execute the programming instructions.

89. The article of claim 88, wherein said article/apparatus is a selected one of a wireless mobile phone, a palm sized computing device, a notebook sized computing device, a desktop computing device, a set-top box and a server.

90. An article of manufacture comprising
a storage medium having a recordable medium; and
a plurality of machine readable programming instructions recorded on said recordable medium of said storage medium, designed to program an apparatus to enable the apparatus to
retrieve a plurality of presence criteria of an application,
determine if the presence criteria are met,
if so, further determine importable data of said application, and
import said importable data of said application.

91. The article of claim 90, wherein said programming instructions are designed to enable the apparatus to perform said retrieving by retrieving said plurality of presence criteria from a desriptor of said application.

92. The article of claim 90, wherein said programming instructions are designed to enable the apparatus to perform said determining if the presence criteria are met by accessing a registry of an operating environment within which said application is installed to verify if said presence criteria are met.

93. The article of claim 90, wherein said article and said apparatus are one of the same, and said article/apparatus further comprises at least one processor coupled to the storage medium to execute the programming instructions.

94. The article of claim 93, wherein said article/apparatus is a selected one of a wireless mobile phone, a palm sized computing device, a notebook sized computing device, a desktop computing device, a set-top box and a server.
